(19) United States
(12) Patent Application Publication
(10) Pub. No.: US 2008/0075141 A1
(43) Pub. Date: Mar. 27, 2008

(54) INFRARED CLINICAL THERMOMETER

(76) Inventors: Vincent WENG, HsinChu (TW); Jason Liao, HsinChu (TW)

Correspondence Address: SINORICA, LLC, 528 FALLSGROVE DRIVE, ROCKVILLE, MD, 20850, US

(21) Appl. No.: 11/751,675

(22) Filed: May 22, 2007

(30) Foreign Application Priority Data
Sep. 22, 2006 (TW) 95135101

(51) Int. Cl. G01J 5/00; G01J 5/04

(52) U.S. Cl. 374/121

(57) ABSTRACT

The present invention discloses an infrared clinical thermometer, which comprises a casing, a temperature-sensing unit at one end of the casing, and a display unit on the casing, wherein the current and former measurement results are simultaneously presented on the display unit to facilitate the comparison of the measurement results.

### BACKGROUND OF THE INVENTION

1. Field of the Invention

The present invention relates to an infrared clinical thermometer, particularly to an infrared clinical thermometer, wherein the current and former temperature measurement results can be simultaneously presented on a same picture.

2. Description of the Related Art

With the advance of science and technology, the clinical thermometer has evolved from the traditional mercury thermometer to the infrared thermometer, such as the infrared ear thermometer or the infrared forehead thermometer. The infrared clinical thermometer has been very popular because it can fast obtain a body temperature within seconds.

Refer to FIG. 1 a diagram schematically showing a conventional infrared clinical thermometer. The conventional infrared clinical thermometer has a casing 10, and a probe 12 is arranged at one end of the casing 10. The probe 12 has an infrared temperature sensor to measure body temperature. The measurement result will be instantly presented on a display unit 14. However, the display unit 14 can present only one measurement result each time, as shown in FIG. 1.

Sometimes, the user performs temperature measurements twice or more to make sure the measurement results. Especially, when the result of the first-time temperature measurement indicates a fever, the user often feels tense and performs temperature measurement once again to make sure whether the former measurement result is the same as the current result or just an error. Nevertheless, the conventional infrared clinical thermometer can present only one measured temperature each time, which inconveniences the comparison of measurement results.

Accordingly, the present invention proposes a convenient and high-touch infrared clinical thermometer to overcome the abovementioned problems.

### SUMMARY OF THE INVENTION

One objective of the present invention is to provide an infrared clinical thermometer, wherein the current and former measurement results can be simultaneously presented on a display, and whereby the user can conveniently compare the current measurement result with the former measurement result.

To achieve the abovementioned objective, the present invention proposes an infrared clinical thermometer, which comprises a thermometer casing; a display unit on the casing; a button unit on the casing; a temperature sensing unit at one end of the casing; and a control circuit inside the casing and coupled to the display unit, the button unit and the temperature sensing unit. When the user presses the button, the control circuit starts the temperature sensing unit to measure temperature. Then, the control circuit will transmit the current measurement result and the former measurement result to the display unit. Thus, the display unit can simultaneously present the current and former measurement results on a same picture, which benefits the user in comparing the measurement results.

Below, the preferred embodiments are described in detail in cooperation with the drawings to make easily understood the characteristics and accomplishments of the present invention.

### BRIEF DESCRIPTION OF THE DRAWINGS

FIG. 1 is a diagram schematically showing a conventional infrared clinical thermometer;

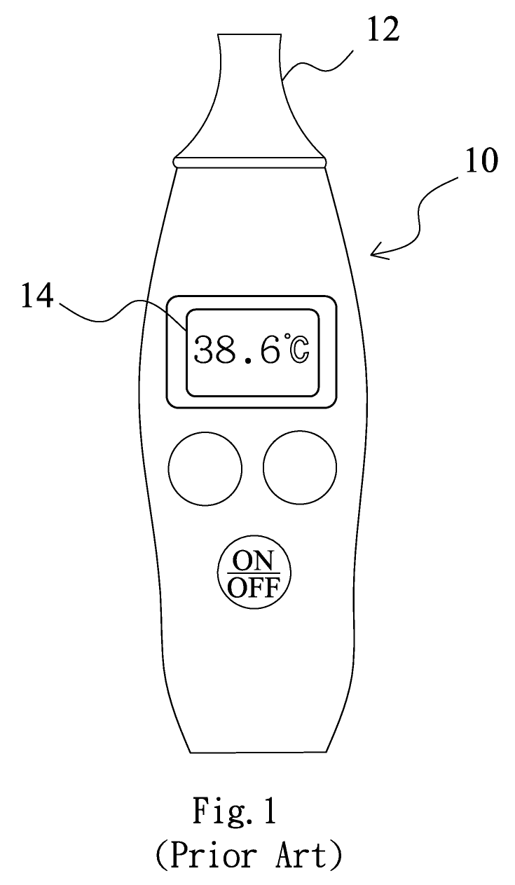

FIG. 2 is a diagram schematically showing an ear thermometer according to the present invention;

FIG. 3 is a block diagram showing the circuit of an ear thermometer according to the present invention; and

FIG. 4 is a diagram schematically showing a displaying method according to the present invention.

### DETAILED DESCRIPTION OF THE INVENTION

The present invention pertains to an infrared clinical thermometer, such as an infrared ear thermometer or an infrared forehead thermometer, wherein the current and former measurement results can be simultaneously presented on a display. Below, the preferred embodiment that the present invention is applied to an ear thermometer is used to demonstrate the technical contents, characteristics and accomplishments of the present invention.

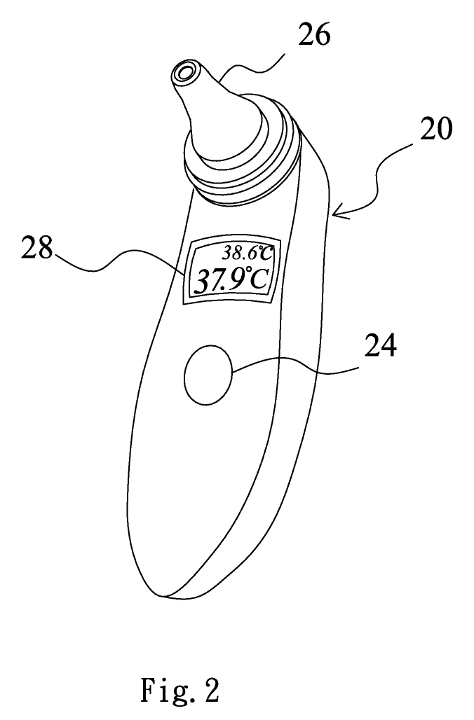

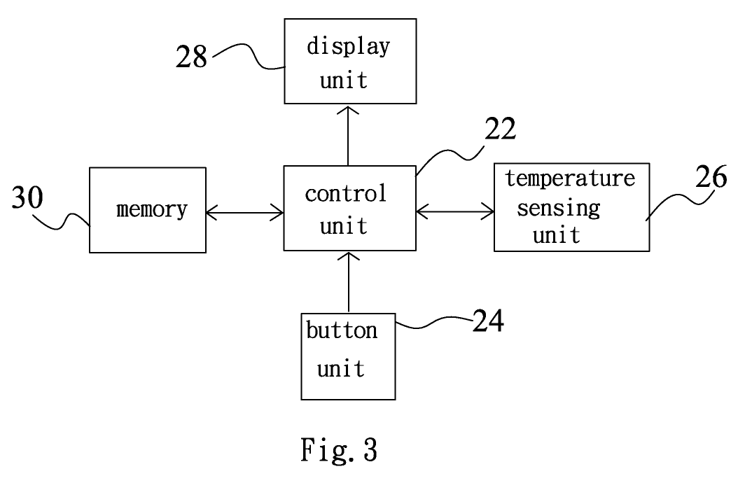

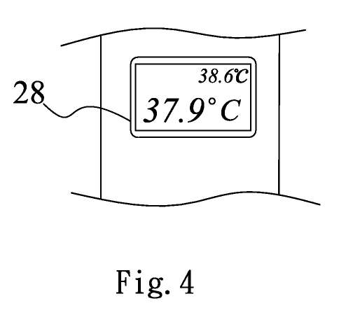

Refer to FIG. 2 and FIG. 3 respectively a diagram schematically showing an ear thermometer according to the present invention and a block diagram showing the circuit of an ear thermometer according to the present invention. The ear thermometer of the present invention comprises a thermometer casing 20; a display unit 28 on the casing 20; a button unit 24 on the casing 20; a temperature sensing unit 26 at one end of the casing 10; and a control circuit 22 (not shown in the drawings) inside the casing 10 and coupled to the display unit 28, the button unit 24 and the temperature sensing unit 26. An infrared temperature sensor (not shown in the drawings) is arranged inside the temperature sensing unit 26 and used to detect temperature. When the user presses the button unit 24, the control circuit 22 starts the temperature sensing unit 26 to measure an ear temperature. The measured temperature is fed back to the control circuit 22. Then, the control circuit 22 transmits the current measurement result and the former measurement result to the display unit 28. Thus, the display unit 28 can simultaneously present the current and former measurement results on a same picture. As shown in FIG. 4, the temperature in the lower area of the display is the current measurement result, and the temperature shown in the upper area is the former measurement result. A memory 30 is coupled to the control circuit 22 and used to store the measurement results. The display unit 28 may be a liquid crystal display device.

The infrared clinical thermometer disclosed by the present invention is a thermometer having the PiP (Picture-in-Picture) feature, which simultaneously presents the current and former measurement results to facilitate the comparison of the measurement results. Thus, via the present invention, neither pen/paper nor retentivity is needed in undertaking a comparison, which can greatly benefit the unretentive elderly.

Those described above are the embodiments to exemplify the present invention to enable the persons skilled in the art to understand, make and use the present invention. However, it is not intended to limit the scope of the present invention. Any equivalent modification or variation according to the spirit of the present invention is to be also included within the scope of the present invention.

What is claimed is:

1. An infrared clinical thermometer comprising:
a casing;
a button unit on said casing;
a temperature-sensing unit at one end of said casing and used to measure temperature;
a control circuit coupled to said button unit and said temperature-sensing unit, triggered by said button unit to start said temperature-sensing unit to perform a temperature measurement, and receiving a result of said temperature measurement from said temperature-sensing unit; and
a display unit on said casing, coupled to said control circuit, and presenting on a same picture both said result of said temperature measurement and a result of a former temperature measurement.

2. The infrared clinical thermometer according to claim 1, wherein an infrared temperature sensor is inside said temperature-sensing unit.

3. The infrared clinical thermometer according to claim 1, wherein said control circuit is coupled to a memory for storing results of temperature measurements.

4. The infrared clinical thermometer according to claim 1, wherein said display unit is a liquid crystal display device.

5. The infrared clinical thermometer according to claim 1, wherein said result of said temperature measurement is presented at a first position of said display unit, and said result of said former temperature measurement is presented at a second position of said display unit.
